(19) United States
(12) Patent Application Publication
(10) Pub. No.: US 2026/0297305 A1
(43) Pub. Date: Oct. 1, 2026

(54) RESIN COMPOSITION AND METHOD FOR STABILIZING ORGANIC MATERIAL

(71) Applicant: SUMITOMO CHEMICAL COMPANY, LIMITED, Tokyo (JP)

(72) Inventor: Fumiaki MATSUOKA, Osaka (JP)

(21) Appl. No.: 19/489,393

(22) PCT Filed: Jun. 6, 2024
(86) PCT No.: PCT/JP2024/020743

§ 371 Date: Dec. 2, 2025

(30) Foreign Application Priority Data
Jun. 21, 2023 (JP) 2023-101931

(51) Int. Cl. C08L 23/06; C08K 5/098; C08K 5/527

(52) U.S. Cl. CPC C08L 23/06; C08K 5/098; C08K 5/527; C08L 2205/02; C08L 2207/066

(57) ABSTRACT

A resin composition including a compound (1) represented by formula (1):

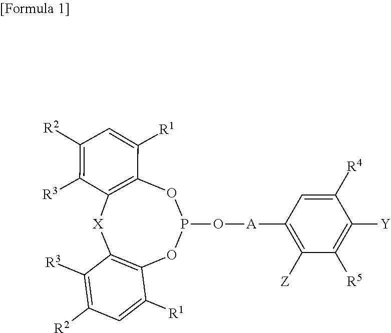

wherein
R¹, R², R⁴ and R⁵ each independently represent a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group,
R³ each independently represents a hydrogen atom or an alkyl group having 1 to 8 carbon atoms,
X represents a single bond, a sulfur atom or a group —CH(—R⁶)—, wherein R⁶ represents a hydrogen atom, an alkyl group having 1 to 8 carbon atoms or a cycloalkyl group having 5 to 8 carbon atoms,
A represents an alkylene group having 1 to 8 carbon atoms or a group *—C(═O)—R⁷—, wherein R⁷ represents a single bond or an alkylene group having 1 to 8 carbon atoms, and * represents a bond to oxygen,
one of Y and Z represents a hydroxyl group, an alkoxy group having 1 to 8 carbon atoms or an aralkyloxy group having 7 to 12 carbon atoms, and the other thereof represents a hydrogen atom or an alkyl group having 1 to 8 carbon atoms,
a polyethylene-based resin (2), and
a polypropylene-based resin (3), in which
an amount of a constituent unit derived from ethylene is 67% by mol or more based on an amount of the entire constituent unit in the polyethylene-based resin (2), and
a proportion of an amount of the polyethylene-based resin (2) to a total amount of the polyethylene-based resin (2) and the polypropylene-based resin (3) is 60% by mass or more and less than 100% by mass.

### TECHNICAL FIELD

The present invention relates to a resin composition and a method for stabilizing an organic material.

### BACKGROUND ART

Resin compositions including polyolefin resins, in particular, polyethylene-based resins and/or polypropylene-based resins are used, for example, in materials for various industrial parts, including interior and exterior parts such as bumpers, instrument panels, door trims and pillars in automobile applications, parts for vacuum cleaners, televisions, and others in home appliance applications, various housing facility equipment parts, various industrial parts, and various building material parts, and in a wide variety of films such as heavy-duty bags, shrinks, general packaging, thin films, protective films (protection films), extrusion laminated films, extruded films, and foam-molded films. Resin compositions constituting these parts and the others may deteriorate due to the action of heat, oxygen and the others during production, during processing, and furthermore during use of these parts and the others, and the commercial value thereof may be significantly impaired with a decrease in the strength and the physical properties of organic materials, a change in their flowability, their coloration, a decrease in their surface properties, and the others due to phenomena such as cleaving and crosslinking of molecules.

For such resin compositions including polyethylene-based resins and/or polypropylene-based resins, for example, Patent Literature 1 and 2 disclose a resin composition including a propylene polymer and an ethylene-propylene copolymer. Patent Literature 2 discloses a thermoplastic polymer composition including a thermoplastic polymer and a specified compatibilizing agent. Patent Literature 3 discloses a polymer composition including an ethylene-based polymer and an ethylene-α-olefin copolymer. Patent Literature 4 discloses a thermoplastic resin composition including a propylene-based copolymer having a propylene unit and an ethylene unit, and a crystalline polypropylene-based resin.

### CITATION LIST

### Patent Literature

Patent Literature 1: Japanese Patent Laid-Open No. 2018-184593
Patent Literature 2: Japanese Patent Laid-Open No. 2021-102747
Patent Literature 3: Japanese Patent Laid-Open No. 2009-1780
Patent Literature 4: Japanese Patent Laid-Open No. 2018-135484

### SUMMARY OF INVENTION

### Problems to be Solved by Invention

Parts as described above may be required to be reduced in weight, and a method for thinning such a part is considered as one method for weight reduction. However, when resin compositions deteriorate due to the action of heat, oxygen and the others to thereby fail to obtain fluidity, parts of thinned shapes may be hardly formed. In addition, when resin compositions are low in fluidity during production of resin composition films, products may be impaired in quality, for example, may cause the variation in film thickness or the occurrence of defects. Furthermore, when resin compositions are low in fluidity, the productivity during production of parts and others described above may also deteriorate. Therefore, although various resin compositions as described above are studied, there is still a demand for an enhancement in fluidity of a resin composition including a polyethylene-based resin and a polypropylene-based resin. The present inventors have particularly focused on the fact that the fluidity of a resin composition including a polyethylene-based resin tends to deteriorate during processing, and have tried to inhibit the fluidity of such a resin composition from deteriorating. Furthermore, a resin composition including a polyethylene-based resin and a polypropylene-based resin is used with uncolored or optionally colored by a pigment or the like depending on required properties of parts and others. In any case, it is desirable for such a resin composition that the change in color thereof, for example, yellowing is suppressed, and that the coloration (for example, the degree of yellowness) derived from the resin composition is reduced.

Accordingly, an object of the present invention is to provide a resin composition including a polyethylene-based resin, the composition exhibiting reduced coloration caused by itself and having excellent fluidity.

### Means to Solve the Problems

The present inventors have particularly made studies on various compounds in order to solve the above problems, and thus have found that a resin composition including a specified compound and a resin is effective, thereby leading to completion of the present invention. Specifically, the present invention provides the following preferred aspects.

[1] A resin composition including
a compound (1) represented by formula (1):

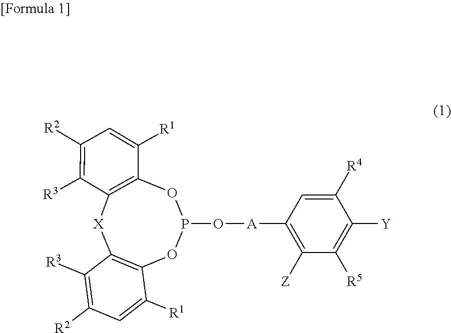

wherein
R¹, R², R⁴ and R⁵ each independently represent a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group,
R³ each independently represents a hydrogen atom or an alkyl group having 1 to 8 carbon atoms,
X represents a single bond, a sulfur atom or a group —CH(—R⁶)—, wherein R⁶ represents a hydrogen atom, an alkyl group having 1 to 8 carbon atoms or a cycloalkyl group having 5 to 8 carbon atoms,
A represents an alkylene group having 1 to 8 carbon atoms or a group *—C(═O)—R⁷—, wherein R⁷ represents a single bond or an alkylene group having 1 to 8 carbon atoms, and * represents a bond to oxygen,
any one of Y and Z represents a hydroxyl group, an alkoxy group having 1 to 8 carbon atoms or an aralkyloxy group having 7 to 12 carbon atoms, and the other thereof represents a hydrogen atom or an alkyl group having 1 to 8 carbon atoms,
a polyethylene-based resin (2), and
a polypropylene-based resin (3), wherein
an amount of a constituent unit derived from ethylene is 67% by mol or more based on an amount of the entire constituent unit in the polyethylene-based resin (2), and
a proportion of an amount of the polyethylene-based resin (2) to a total amount of the polyethylene-based resin (2) and the polypropylene-based resin (3) is 60% by mass or more and less than 100% by mass.

[2] The resin composition according to [1], wherein an amount of the compound (1) is 0.01 to 3% by mass based on the total amount of the polyethylene-based resin (2) and the polypropylene-based resin (3).

[3] The resin composition according to [1] or [2], wherein an amount of a constituent unit derived from propylene is 60% by mol or more based on an amount of the entire constituent unit in the polypropylene-based resin (3).

[4] The resin composition according to any one of [1] to [3], wherein the amount of the constituent unit derived from ethylene is 80% by mol or more based on the amount of the entire constituent unit in the polyethylene-based resin (2).

[5] The resin composition according to any one of [1] to [4], wherein a total amount of the compound (1), the polyethylene-based resin (2) and the polypropylene-based resin (3) is 60% by mass or more based on a whole amount of the resin composition.

[6] The resin composition according to any one of [1] to [5], wherein the proportion of the amount of the polyethylene-based resin (2) to the total amount of the polyethylene-based resin (2) and the polypropylene-based resin (3) is 60% by mass or more and 99.9% by mass or less.

[7] The resin composition according to any one of [1] to [6], wherein the proportion of the amount of the polyethylene-based resin (2) to the total amount of the polyethylene-based resin (2) and the polypropylene-based resin (3) is 80% by mass or more and 99.9% by mass or less.

[8] The resin composition according to any one of [1] to [7], wherein the proportion of the amount of the polyethylene-based resin (2) to the total amount of the polyethylene-based resin (2) and the polypropylene-based resin (3) is 80% by mass or more and 99.5% by mass or less.

[9] The resin composition according to any one of [1] to [8], wherein in the polyethylene-based resin (2) and/or the polypropylene-based resin (3), an amount of a constituent unit derived from a diene-based monomer is 3% by mol or less based on an amount of the entire constituent unit.

[10] The resin composition according to any one of [1] to [9], wherein a density of the polyethylene-based resin (2) is 875 kg/m³ or more and 980 kg/m³ or less.

[11] The resin composition according to any one of [1] to [10], wherein the polyethylene-based resin (2) is high density polyethylene, low density polyethylene or linear low density polyethylene.

[12] A method for stabilizing an organic material, the method including adding a compound (1) represented by formula (1):

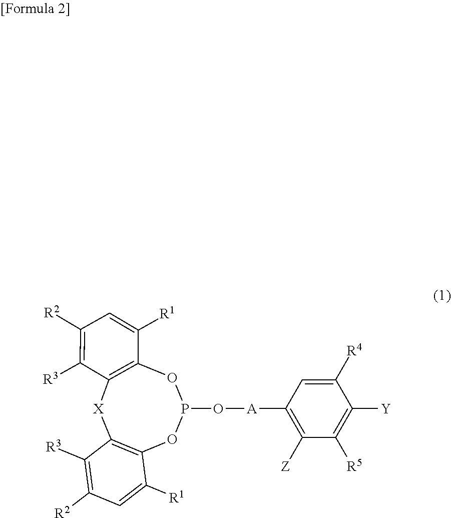

wherein
R¹, R², R⁴ and R⁵ each independently represent a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group,
R³ each independently represents a hydrogen atom or an alkyl group having 1 to 8 carbon atoms,
X represents a single bond, a sulfur atom or a group —CH(—R⁶)—, wherein R⁶ represents a hydrogen atom, an alkyl group having 1 to 8 carbon atoms or a cycloalkyl group having 5 to 8 carbon atoms,
A represents an alkylene group having 1 to 8 carbon atoms or a group *—C(═O)—R⁷—, wherein R⁷ represents a single bond or an alkylene group having 1 to 8 carbon atoms, and * represents a bond to oxygen,
one of Y and Z represents a hydroxyl group, an alkoxy group having 1 to 8 carbon atoms or an aralkyloxy group having 7 to 12 carbon atoms, and the other thereof represents a hydrogen atom or an alkyl group having 1 to 8 carbon atoms,
   to an organic material containing a polyethylene-based resin (2) and a polypropylene-based resin (3), wherein
an amount of a constituent unit derived from ethylene is 67% by mol or more based on an amount of the entire constituent unit in the polyethylene-based resin (2), and
a proportion of an amount of the polyethylene-based resin (2) to a total amount of the polyethylene-based resin (2) and the polypropylene-based resin (3) is 60% by mass or more and less than 100% by mass.

### Effect of Invention

According to the present invention, it is possible to provide a resin composition exhibiting reduced coloration of the resin composition itself and having excellent fluidity.

### EMBODIMENTS FOR CARRYING OUT INVENTION

Embodiments of the present invention will be described in detail below. The scope of the present invention is not limited to the embodiments described here, and various changes can be made without departing from the spirit of the present invention. When a plurality of upper limit values and a plurality of lower limit values are described for a specified feature, any upper limit value and any lower limit value among these upper limit values and these lower limit values can be combined to provide a suitable numerical value range.

### [Compound (1)]

The resin composition of the present invention relates to a resin composition including a compound (1) represented by formula (1):

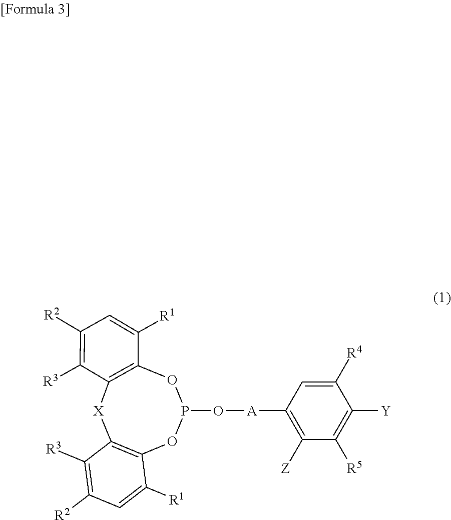

wherein
R¹, R², R⁴ and R⁵ each independently represent a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group,
R³ each independently represents a hydrogen atom or an alkyl group having 1 to 8 carbon atoms, X represents a single bond, a sulfur atom or a group —CH(—R⁶)—, wherein R⁶ represents a hydrogen atom, an alkyl group having 1 to 8 carbon atoms or a cycloalkyl group having 5 to 8 carbon atoms,
A represents an alkylene group having 1 to 8 carbon atoms or a group *—C(═O)—R⁷—, wherein R⁷ represents a single bond or an alkylene group having 1 to 8 carbon atoms, and * represents a bond to oxygen,
one of Y and Z represents a hydroxyl group, an alkoxy group having 1 to 8 carbon atoms or an aralkyloxy group having 7 to 12 carbon atoms, and the other thereof represents a hydrogen atom or an alkyl group having 1 to 8 carbon atoms,
a polyethylene-based resin (2) having a constituent unit derived from ethylene in an amount of 67% by mol or more, and a polypropylene-based resin (3), wherein a proportion of an amount of the polyethylene-based resin (2) to a total amount of the polyethylene-based resin (2) and the polypropylene-based resin (3) is 60% by mass or more and less than 100% by mass.

The resin composition, which includes the compound (1) represented by formula (1), the polyethylene-based resin (2) having a constituent unit derived from ethylene in an amount of 67% by mol or more, and the polypropylene-based resin (3) and has a proportion of the amount of the polyethylene-based resin (2) to the total amount of the polyethylene-based resin (2) and the polypropylene-based resin (3) of 60% by mass or more and less than 100% by mass, surprisingly suppresses a decrease in fluidity and suppresses coloration of the resin composition itself during processing of the resin composition. Although the reason for this is not clear, it is inferred that not only the compound (1) is effective for enhancing stability, but also interaction between the polyethylene-based resin (2) and the polypropylene-based resin (3) inhibits change of the compound (1) and others into colored substances. It is considered that, when a predetermined amount of polypropylene is present relative to predetermined polyethylene, polypropylene or a polypropylene-derived component captures a radical which can be generated in the resin composition, such as a phenoxy radical, inhibits generation of a quinone compound, which causes coloration, and therefore inhibits coloration. However, the present invention is not limited to the above mechanism at all.

The resin composition of the present invention may contain one compound (1) represented by formula (1), or may contain two or more compounds (1) represented by formula (1). R¹, R², R⁴ and R⁵ in formula (1) each independently represent a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group. A plurality of R¹ may be the same or different from each other. The same also applies to R² and R³.

Examples of the alkyl group having 1 to 8 carbon atoms include a methyl group, an ethyl group, a n-propyl group, an isopropyl group, a n-butyl group, a sec-butyl group, a t-butyl group, a n-pentyl group, a t-amyl group, a 2-methylbutyl group, a 3-methylbutyl group, a 2-ethylpropyl group, a n-hexyl group, a n-heptyl group, an isoheptyl group, a n-octyl group, an isooctyl group, and a 2-ethylhexyl group.

Examples of the cycloalkyl group having 5 to 8 carbon atoms include a cyclopentyl group, a cyclohexyl group, a cycloheptyl group and a cyclooctyl group.

Examples of the alkylcycloalkyl group having 6 to 12 carbon atoms include a 1-methylcyclopentyl group, a 1-methylcyclohexyl group and a 1-methyl-4-i-propylcyclohexyl group.

Examples of the aralkyl group having 7 to 12 carbon atoms include a benzyl group, an α-methylbenzyl group and an α,α-dimethylbenzyl group.

R¹, R² and R⁴ are each preferably an alkyl group having 1 to 8 carbon atoms, a cycloalkyl group having 5 to 8 carbon atoms, or an alkylcycloalkyl group having 6 to 12 carbon atoms.

R¹ and R⁴ are each more preferably a t-alkyl group such as a t-butyl group, a t-amyl group or a t-octyl group, a cyclohexyl group or a 1-methylcyclohexyl group.

R² is more preferably an alkyl group having 1 to 5 carbon atoms, such as a methyl group, an ethyl group, a n-propyl group, an i-propyl group, a n-butyl group, an i-butyl group, a sec-butyl group, a t-butyl group or a t-amyl group, and further preferably a methyl group, a t-butyl group, or a t-amyl group.

R⁵ is preferably a hydrogen atom, an alkyl group having 1 to 8 carbon atoms, or a cycloalkyl group having 5 to 8 carbon atoms, more preferably a hydrogen atom, or an alkyl group having 1 to 5 carbon atoms, such as a methyl group, an ethyl group, a n-propyl group, an i-propyl group, a n-butyl group, an i-butyl group, a sec-butyl group, a t-butyl group, or a t-amyl group.

R³ in formula (1) each independently represents a hydrogen atom or an alkyl group having 1 to 8 carbon atoms. Examples of the alkyl group having 1 to 8 carbon atoms include those as described above. R³ is preferably a hydrogen atom or an alkyl group having 1 to 5 carbon atoms, and more preferably a hydrogen atom or a methyl group.

X in formula (1) represents a single bond, a sulfur atom or a group —CH(—R⁶)—, wherein R⁶ represents a hydrogen atom, an alkyl group having 1 to 8 carbon atoms or a cycloalkyl group having 5 to 8 carbon atoms. Examples of the alkyl group having 1 to 8 carbon atoms represented by R⁶, and the cycloalkyl group having 5 to 8 carbon atoms include those as described above. X is preferably a methylene group substituted with an alkyl group having 1 to 4 carbon atoms, such as a methyl group, an ethyl group, a n-propyl group, an i-propyl group, a n-butyl group, an i-butyl group, or a t-butyl group, or a single bond, and more preferably a single bond.

A in formula (1) represents an alkylene group having 1 to 8 carbon atoms or a group *—C(═O)—R⁷—, wherein R⁷ represents a single bond or an alkylene group having 1 to 8 carbon atoms, and * represents a bond to oxygen. Examples of the alkylene group having 1 to 8 carbon atoms include a methylene group, an ethylene group, a propylene group, a butylene group, a pentamethylene group, a hexamethylene group, an octamethylene group and a 2,2-dimethyl-1,3-propylene group. A is preferably a propylene group. * in the group *—C(═O)—R⁷-means that the carbonyl group is bonded to the oxygen atom of the phosphite group. R⁷ is preferably a single bond or an ethylene group.

Any one of Y and Z in the formula (1) represents a hydroxyl group, an alkoxy group having 1 to 8 carbon atoms or an aralkyloxy group having 7 to 12 carbon atoms, and the other thereof represents a hydrogen atom or an alkyl group having 1 to 8 carbon atoms. Examples of the alkyl group having 1 to 8 carbon atoms include those as described above. Examples of the aralkyloxy group having 7 to 12 carbon atoms include a benzyloxy group, an α-methylbenzyloxy group and an α, α-dimethylbenzyloxy group. Preferably, any one of Y and Z is a hydroxyl group and the other thereof is a hydrogen atom or an alkyl group having 1 to 8 carbon atoms. More preferably, Y is a hydroxyl group and Z is a hydrogen atom or an alkyl group having 1 to 8 carbon atoms.

Specific examples of the compound represented by formula (1) include 2, 4, 8, 10-tetra-t-butyl-6-[3-(3-methyl-4-hydroxy-5-t-butylphenyl)propoxy]dibenzo[d, f][1, 3, 2]dioxaphosphepine, 6-[3-(3,5-di-t-butyl-4-hydroxyphenyl) propoxy]-2, 4, 8, 10-tetra-t-butyldibenzo[d, f][1, 3, 2]dioxaphosphepine, 6-[3-(3, 5-di-t-butyl-4-hydroxyphenyl) propoxy]-4,8-di-t-butyl-2, 10-dimethyl-12H-dibenzo[d, g][1, 3, 2]dioxaphosphocin, and 6-[3-(3,5-di-t-butyl-4-hydroxyphenyl) propionyloxy]-4, 8-di-t-butyl-2, 10-dimethyl-12H-dibenzo[d, g][1, 3, 2]dioxaphosphocin. The compound represented by formula (1) is preferably 2, 4, 8, 10-tetra-t-butyl-6-[3-(3-methyl-4-hydroxy-5-t-butylphenyl) propoxy]dibenzo[d, f][1, 3, 2]dioxaphosphepine.

A commercially available product can also be used as the compound represented by formula (1). Examples of the commercially available product include Sumilizer (R) GP (manufactured by Sumitomo Chemical Co., Ltd.).

### [Polyethylene-Based Resin (2)]

The resin composition of the present invention further contains a polyethylene-based resin (2), and the polyethylene-based resin (2) is a polyethylene-based resin in which the amount of a constituent unit derived from ethylene is 67% by mol or more based on the amount of the entire constituent unit. The resin composition may contain one polyethylene-based resin (2), or may contain two or more polyethylene-based resins (2). The amount of the constituent unit derived from ethylene is 67% by mol or more, preferably 70% by mol or more, more preferably 80% by mol or more, further preferably 85% by mol or more, and especially preferably 90% by mol or more, based on the amount of the entire constituent unit in the polyethylene-based resin (2), and the upper limit thereof may be 100% by mol or less. The amount of the constituent unit derived from ethylene based on the amount of the entire constituent unit can be determined by a nuclear magnetic resonance method (NMR method) and/or an infrared spectroscopic method (IR method).

Examples of the polyethylene-based resin (2) include polyethylene (ethylene homopolymer) and a copolymer of ethylene and any other monomer.

The polyethylene-based resin (2) is not particularly limited as long as the amount of the constituent unit derived from ethylene is 67% by mol or more based on the amount of the entire constituent unit, and the polyethylene-based resin may be homopolyethylene in which all constituent units are derived from ethylene, or may be a copolymer of ethylene and one or more other monomers. Examples of such other monomers include α-olefins, conjugated dienes (for example, butadiene and isoprene), non-conjugated dienes (for example, 1,4-pentadiene), acrylic acid, acrylates (for example, methyl acrylate and ethyl acrylate), methacrylic acid, methacrylates (for example, methyl methacrylate and ethyl methacrylate), and vinyl acetate.

The polyethylene-based resin (2) may be, for example, an ethylene-α-olefin copolymer. The polyethylene-based resin (2) may be preferably low density polyethylene (LDPE), linear low density polyethylene (LLDPE), or high density polyethylene (HDPE).

The density of the polyethylene-based resin (2) is preferably 875 kg/m³ or more and 980 kg/m³ or less, more preferably 880 kg/m³ or more and 970 kg/m³ or less, and further preferably 900 kg/m³ or more and 970 kg/m³ or less, in view of enhancing mechanical strength and rigidity. Herein, the density of the polyethylene-based resin (2) is measured by the method A prescribed in JIS K7112-1980. It is considered that, when a resin composition contains a polyethylene-based resin (2) having a density in the above range, the resin composition provided can be such that it is not only excellent in fluidity and coloring resistance during processing, but also favorable in mechanical properties and others.

The ethylene-α-olefin copolymer is a copolymer containing a constituent unit derived from ethylene and a constituent unit derived from α-olefin. Examples of the α-olefin include propylene, 1-butene, 1-pentene, 1-hexene, 1-heptene, 1-octene, 1-nonene, 1-decene, 1-dodecene, 4-methyl-1-pentene, and 4-methyl-1-hexene, and these may be used singly, or in combinations of two or more thereof. The α-olefin is preferably an α-olefin having 3 to 20 carbon atoms, more preferably an &-olefin having 4 to 8 carbon atoms, and further preferably at least one α-olefin selected from 1-butene, 1-hexene, 1-octene, and 4-methyl-1-pentene.

The melt flow rate (MFR) of the polyethylene-based resin (2) is 0.1 to 20 g/10 min. The MFR is preferably 0.3 g/10 min or more, and more preferably 0.5 g/10 min or more in view of the fluidity and the processability of the resin composition. The MFR is preferably 10 g/10 min or less, and more preferably 5 g/10 min or less, in view of mechanical strength. The melt flow rate is a value measured by the method A under the conditions of a temperature of 190° C. and a load of 21.18 N according to the method prescribed in JIS K7210-2014.

The content of the polyethylene-based resin (2) is preferably 60 to 99.9% by mass, more preferably 70 to 99.5% by mass, and further preferably 80 to 99.0% by mass, based on the whole amount of the resin composition, in view of the fluidity, the coloring resistance and the mechanical strength of the resin composition.

### [Polypropylene-Based Resin (3)]

The resin composition of the present invention further contains a polypropylene-based resin (3). Herein, the polypropylene-based resin is a polypropylene-based resin in which the amount of a constituent unit derived from propylene is largest in the entire constituent unit contained in the polypropylene-based resin (3). For example, a certain resin, in which the amount of a constituent unit derived from propylene is more than 50% by mol based on the amount of the entire constituent unit is the polypropylene-based resin (3). For example, a certain resin having constituent units derived from plural kinds of monomers is also the polypropylene-based resin (3), if the amount of the constituent unit derived from polypropylene is larger than the respective amounts of constituent units of the other monomers in comparison of the amounts of the constituent units derived from the monomers.

The resin composition may contain one polypropylene-based resin (3), or may contain two or more polypropylene-based resins (3). The amount of the constituent unit derived from propylene is preferably more than 50% by mol, more preferably 60% by mol or more, further preferably 70% by mol or more, still more preferably 80% by mol or more, and especially preferably 90% by mol or more, based on the amount of the entire constituent unit in the polypropylene-based resin (3), in view of the fluidity, the coloring resistance and the mechanical strength of the resin composition, and the upper limit thereof may be 100% by mol or less. The amount of the constituent unit derived from propylene based on the amount of the entire constituent unit can be determined by a nuclear magnetic resonance method (NMR method) and/or an infrared spectroscopic method (IR method).

Examples of the polypropylene-based resin (3) include polypropylene (propylene homopolymer) and a copolymer of propylene and any other monomer, and examples include isotactic polypropylene, syndiotactic polypropylene, atactic polypropylene, a propylene-α-olefin copolymer, and an ethylene·propylene·copolymer.

The polypropylene-based resin (3) is a resin in which the amount of the constituent unit derived from propylene is largest when the amounts of respective constituent units contained in the resin are compared. The polypropylene-based resin is not particularly limited as long as it is such a resin, and the polypropylene-based resin may be homopolypropylene in which all constituent units are derived from propylene, or may be a copolymer of propylene and one or more other monomers. Examples of such other monomers include ethylene, α-olefins, conjugated dienes (for example, butadiene and isoprene), non-conjugated dienes (for example, 1,4-pentadiene), acrylic acid, acrylates (for example, methyl acrylate and ethyl acrylate), methacrylic acid, methacrylates (for example, methyl methacrylate and ethyl methacrylate), and vinyl acetate.

The melt flow rate (MFR) of the polypropylene-based resin (3) is preferably 0.1 g/10 min to 150 g/10 min, more preferably 0.5 g/10 min to 100 g/10 min, and further preferably 1 g/10 min to 50 g/10 min, in view of enhancing the fluidity and the mechanical strength of the resin composition. The melt flow rate is a value measured by the method A under the conditions of a temperature of 230° C. and a load of 21.18 N according to the method prescribed in JIS K7210-2014.

The content of the polypropylene-based resin (3) is preferably 0.01 to 50% by mass, more preferably 0.1 to 40% by mass, further preferably 0.5 to 25% by mass, and still more preferably 1.0 to 15% by mass, based on the whole amount of the resin composition, in view of suppression of the coloration of the resin composition itself.

In the polyethylene-based resin (2) and/or the polypropylene-based resin (3), the amount of a constituent unit derived from a diene-based monomer based on the amount of the entire constituent unit is more preferably smaller, and is, for example, preferably 3% by mol or less, more preferably 2% by mol or less, and further preferably 1% by mol or less.

### [Resin Composition]

As described above, the resin composition of the present invention is a resin composition including a compound (1) represented by formula (1), a polyethylene-based resin (2) having a constituent unit derived from ethylene in an amount of 67% by mol or more based on the amount of the entire constituent unit, and a polypropylene-based resin (3), wherein the proportion of the amount of the polyethylene-based resin (2) to the total amount of the polyethylene-based resin (2) and the polypropylene-based resin (3) is 60% by mass or more and less than 100% by mass.

When the proportion of the amount of the polyethylene-based resin (2) to the total amount of the polyethylene-based resin (2) and the polypropylene-based resin (3) included in the resin composition is less than 60% by mass and when the proportion is 100% by mass, the resin composition itself is easily colored and the color derived from the resin composition tends to be more intense. The proportion of the amount of the polyethylene-based resin (2) to the total amount of the polyethylene-based resin (2) and the polypropylene-based resin (3) included in the resin composition is preferably 60% by mass or more and 99.9% by mass or less, more preferably 80% by mass or more and 99.9% by mass or less, further preferably 80% by mass or more and 99.5% by mass or less, and still more preferably 85% by mass or more and 99.0% by mass or less, in view of suppression of the coloration of the resin composition itself.

The amount of the compound (1) is preferably 0.01 to 3% by mass, more preferably 0.02 to 1% by mass, further preferably 0.03 to 0.5% by mass, and still more preferably 0.05 to 0.3% by mass, based on the total amount of the polyethylene-based resin (2) and the polypropylene-based resin (3) included in the resin composition, in view of suppression of the coloration of the resin composition itself.

The total amount of the compound (1), the polyethylene-based resin (2) and the polypropylene-based resin (3) is preferably 60% by mass or more, more preferably 70% by mass or more, further preferably 80% by mass or more, and still more preferably 90% by mass or more, and may be, for example, 95% by mass or more, 98% by mass or more, or 99% by mass, based on the whole amount of the resin composition, in view of suppression of the coloration of the resin composition itself.

The YI of the resin composition of the present invention is preferably 20 or less, more preferably 15 or less, further preferably 12 or less, still more preferably 10 or less, particularly preferably 8 or less, and most preferably 6 or less in view of easily enhancing the quality of a molded article obtained from the resin composition of the present invention. The YI of the resin composition may be, for example, measured using a colorimeter on a molded article (sheet) obtained by press molding the resin composition, as a measurement sample, and can be measured by, for example, a method described in Examples.

### [Other Resin]

As described above, the resin composition of the present invention includes the compound (1), the polyethylene-based resin (2) and the polypropylene-based resin (3), wherein the amount of the constituent unit derived from ethylene is 67% by mol or more based on the amount of the entire constituent unit in the polyethylene-based resin (2) and the proportion of the amount of the polyethylene-based resin (2) to the total amount of the polyethylene-based resin (2) and the polypropylene-based resin (3) is 60% by mass or more and less than 100% by mass. The resin composition may further contain one or more other resins and/or additives different from the polyethylene-based resin (2) and the polypropylene-based resin (3).

Examples of such other resins include
(1) polyethylene-based resins each containing a constituent unit derived from ethylene in an amount of less than 67% by mol,
(2) resins each containing a constituent unit derived from polypropylene and other constituent unit having 4 or more carbon atoms, in which the content of the constituent unit derived from propylene is lower than the whole amount of such other constituent unit having 4 or more carbon atoms,
(3) methylpentene polymers,
(4) EEA (ethylene/ethyl acrylate copolymer) resins,
(5) ethylene/vinyl acetate copolymer resins,
(6) polystyrenes, for example, polystyrene, poly(p-methylstyrene), poly(α-methylstyrene),
(7) AS (acrylonitrile/styrene copolymer) resins,
(8) ABS (acrylonitrile/butadiene/styrene copolymer) resins,
(9) AAS (special acrylic rubber/acrylonitrile/styrene copolymer) resins,
(10) ACS (acrylonitrile/chlorinated polyethylene/styrene copolymer) resins,
(11) chlorinated polyethylene, polychloroprene, and chlorinated rubbers,
(12) polyvinyl chloride and polyvinylidene chloride,
(13) methacrylic resins,
(14) ethylene/vinyl alcohol copolymer resins,
(15) fluororesins,
(16) polyacetals,
(17) grafted polyphenylene ether resins and polyphenylene sulfide resins,
(18) polyurethanes,
(19) polyamides,
(20) polyester resins, for example, polyethylene terephthalate and polybutylene terephthalate,
(21) polycarbonates,
(22) polyacrylates,
(23) polysulfone, polyetheretherketone, and polyethersulfone,
(24) thermoplastic resins such as aromatic polyester resins,
(25) epoxy resins,
(26) diallyl phthalate prepolymers,
(27) silicone resins,
(28) unsaturated polyester resins,
(29) acrylic-modified benzoguanamine resins,
(30) benzoguanamine/melamine resins,
(31) thermosetting resins such as urea resins,
(32) polybutadiene,
(33) 1,2-polybutadiene,
(34) polyisoprene,
(35) styrene/butadiene copolymers,
(36) butadiene/acrylonitrile copolymers,
(37) ethylene/propylene copolymers,
(38) silicone rubbers,
(39) epichlorohydrin rubbers,
(40) acrylic rubbers,
(41) natural rubbers,
(42) chlorine rubber-based paints,
(43) polyester resin paints,
(44) urethane resin paints,
(45) epoxy resin paints,
(46) acrylic resin paints,
(47) vinyl resin paints,
(48) aminoalkyd resin paints,
(49) alkyd resin paints,
(50) nitrocellulose resin paints,
(51) oil paints,
(52) waxes,
(53) lubricating oils, and the like.

### [Other Additive]

In addition to the compound (1), the polyethylene-based resin (2), and the polypropylene-based resin (3), other additives can also be added to the resin composition, if necessary, including sulfur-based antioxidants, phosphorus-based antioxidants, age resisters, ultraviolet absorbing agents, light stabilizers, peroxide scavengers, polyamide stabilizers, hydroxyamine, lubricants, plasticizers, flame retardants, nucleating agents, metal deactivators, antistatic agents, pigments, fillers, antiblocking agents, surfactants, processing aids, foaming agents, emulsifiers, brighteners, calcium stearate, neutralizing agents such as hydrotalcite, furthermore coloration improving agents such as 9,10-dihydro-9-oxa-10-phosphophenanthrene-10-oxide, and auxiliary stabilizers such as benzofurans and indolines disclosed in U.S. Pat. Nos. 4,325,853, 4,338,244, 5,175,312, 5,216,053, 5,252,643, 4,316,611, DE-A-4,316,622 and 4,316,876, EP-A-589,839, and EP-A-591,102. The additives may be used singly or in combinations of two or more thereof.

Examples of the phenol-based antioxidants include the following. As such a phenol-based antioxidant, the following compounds may be used singly, or in combinations of two or more thereof. It is noted that any compound corresponding to formula (1) is excluded.

### (1) Examples of Alkylated Monophenols

2, 6-dicyclopentyl-4-methylphenol, 2-(α-methylcyclohexyl)-4, 6-dimethylphenol, 2, 6-dioctadecyl-4-methylphenol, 2, 4, 6-tricyclohexylphenol, 2, 6-di-t-butyl-4-methoxymethylphenol, 2, 4-dimethyl-6-(1′-methylundecyl-1′-yl)phenol, 2, 4-dimethyl-6-(1′-methylheptadecyl-1′-yl)phenol, 2, 4-dimethyl-6-(1′-methyltridecyl-1′-yl)phenol, and mixtures thereof, and the like.

### (2) Examples of Alkylthiomethylphenols

2, 4-Dioctylthiomethyl-6-t-butylphenol, 2, 4-dioctylthiomethyl-6-methylphenol, 2, 4-dioctylthiomethyl-6-ethylphenol, 2, 6-didodecylthiomethyl-4-nonylphenol, and mixtures thereof, and the like.

### (3) Examples of Hydroquinones and Alkylated Hydroquinones

2, 6-Di-t-butyl-4-methoxyphenol, 2, 5-di-t-butylhydroquinone, 2, 5-di-t-amylhydroquinone, 2, 6-diphenyl-4-octadecyloxyphenol, 2, 6-di-t-butylhydroquinone, 2, 5-di-t-butyl-4-hydroxyanisole, 3,5-di-t-butyl-4-hydroxyphenyl stearate, bis(3,5-di-t-butyl-4-hydroxyphenyl) adipate, and mixtures thereof, and the like.

### (4) Examples of Tocopherols

α-Tocopherol, β-tocopherol, γ-tocopherol, δ-tocopherol, and mixtures thereof, and the like.

### (5) Examples of Hydroxylated Thiodiphenyl Ethers

2, 2′-Thiobis(6-t-butylphenol), 2, 2′-thiobis(4-methyl-6-t-butylphenol), 2, 2′-thiobis(4-octylphenol), 4, 4′-thiobis(3-methyl-6-t-butylphenol), 4,4′-thiobis(2-methyl-6-t-butylphenol), 4,4′-thiobis(3,6-di-t-amylphenol), 4,4′-(2,6-dimethyl-4-hydroxyphenyl) disulfide, and the like.

### (6) Examples of Alkylidene Bisphenols and Derivatives Thereof

2, 2′-Methylenebis(4-methyl-6-t-butylphenol), 2, 2′-methylenebis(4-ethyl-6-t-butylphenol), 2, 2′-methylenebis[4-methyl-6-(α-methylcyclohexyl)phenol)], 2, 2′-methylenebis(4-methyl-6-cyclohexylphenol), 2, 2′-methylenebis(4-methyl-6-nonylphenol), 2, 2′-methylenebis(4,6-di-t-butylphenol), 2, 2′-ethylidenebis(4,6-di-t-butylphenol), 2, 2′-ethylidenebis(4-isobutyl-6-t-butylphenol), 2, 2′-methylenebis[6-(α-methylbenzyl)-4-nonylphenol], 2, 2′-methylenebis[4, 6-(α, α-dimethylbenzyl)-4-nonylphenol], 4, 4′-methylenebis(6-t-butyl-2-methylphenol), 4,4′-methylenebis(2,6-di-t-butylphenol), 4,4′-butylidenebis(3-methyl-6-t-butylphenol), 1,1-bis(4-hydroxyphenyl)cyclohexane, 1,1-bis(5-t-butyl-4-hydroxy-2-methylphenyl)butane, 2, 6-bis(3-t-butyl-5-methyl-2-hydroxybenzyl)-4-methylphenol, 1, 1, 3-tris(5-t-butyl-4-hydroxy-2-methylphenyl)butane, 1,1-bis(5-t-butyl-4-hydroxy-2-methylphenyl)-3-n-dodecylmercaptobutane, ethylene glycol bis[3,3-bis-3′-t-butyl-4′-hydroxyphenyl) butyrate], bis(3-t-butyl-4-hydroxy-5-methylphenyl) dicyclopentadiene, bis[2-(3′-t-butyl-2′-hydroxy-5′-methylbenzyl)-6-t-butyl-4-methylphenyl]terephthalate, 1,1-bis(3, 5-dimethyl-2-hydroxyphenyl)butane, 2,2-bis(3, 5-di-t-butyl-4-hydroxyphenyl) propane, 2,2-bis(5-t-butyl-4-hydroxy-2-methylphenyl)-4-n-dodecylmercaptobutane, 1, 1, 5, 5-tetra(5-t-butyl-4-hydroxy-2-methylphenyl) pentane, 2-t-butyl-6-(3′-t-butyl-5′-methyl-2′-hydroxybenzyl)-4-methylphenyl acrylate, 2, 4-di-t-pentyl-6-[1-(2-hydroxy-3,5-di-t-pentylphenyl)ethyl]phenyl acrylate, and mixtures thereof, and the like.

### (7) Examples of O—, N—, and S-Benzyl Derivatives

3, 5, 3′, 5′-Tetra-t-butyl-4,4′-dihydroxydibenzyl ether, octadecyl-4-hydroxy-3, 5-dimethylbenzylmercaptoacetate, tris(3,5-di-t-butyl-4-hydroxybenzyl) amine, bis(4-t-butyl-3-hydroxy-2, 6-dimethylbenzyl) dithioterephthalate, bis(3,5-di-t-butyl-4-hydroxybenzyl) sulfide, isooctyl-3, 5-di-t-butyl-4-hydroxybenzylmercaptoacetate, and mixtures thereof, and the like.

### (8) Examples of Hydroxybenzylated Malonate Derivatives

Dioctadecyl-2, 2-bis(3, 5-di-t-butyl-2-hydroxybenzyl) malonate, dioctadecyl-2-(3-t-butyl-4-hydroxy-5-methylbenzyl)malonate, didodecylmercaptoethyl-2, 2-bis(3,5-di-t-butyl-4-hydroxybenzyl)malonate, bis[4-(1, 1, 3, 3-tetramethylbutyl)phenyl]-2, 2-bis(3, 5-di-t-butyl-4-hydroxybenzyl)malonate, and mixtures thereof, and the like.

### (9) Examples of Aromatic Hydroxybenzyl Derivatives

1, 3, 5-Trimethyl-2, 4, 6-tris(3, 5-di-t-butyl-4-hydroxybenzyl)benzene, 1, 4-bis(3, 5-di-t-butyl-4-hydroxybenzyl)-2, 3, 5, 6-tetramethylbenzene, 2, 4, 6-tris(3, 5-t-butyl-4-hydroxybenzyl)phenol, and mixtures thereof, and the like.

### (10) Examples of Triazine Derivatives

2, 4-Bis(n-octylthio)-6-(4-hydroxy-3,5-di-t-butylanilino)-1, 3, 5-triazine, 2-n-octylthio-4, 6-bis(4-hydroxy-3,5-di-t-butylanilino)-1, 3, 5-triazine, 2-n-octylthio-4, 6-bis(4-hydroxy-3,5-di-t-butylphenoxy)-1, 3, 5-triazine, 2, 4, 6-tris(3, 5-di-t-butyl-4-phenoxy)-1, 3, 5-triazine, tris(4-t-butyl-3-hydroxy-2, 6-dimethylbenzyl) isocyanurate, tris(3,5-di-t-butyl-4-hydroxybenzyl) isocyanurate, 2, 4, 6-tris(3, 5-di-t-butyl-4-hydroxyphenylethyl)-1, 3, 5-triazine, 2, 4, 6-tris(3,5-di-t-butyl-4-hydroxyphenylpropyl)-1, 3, 5-triazine, tris(3, 5-dicyclohexyl-4-hydroxybenzyl)isocyanurate, tris[2-(3′, 5′-di-t-butyl-4′-hydroxycinnamoyloxy)ethyl]isocyanurate, and mixtures thereof, and the like.

### (11) Examples of Benzylphosphonate Derivatives

Dimethyl-3, 5-di-t-butyl-4-hydroxybenzylphosphonate, diethyl-3, 5-di-t-butyl-4-hydroxybenzylphosphonate, dioctadecyl-3, 5-di-t-butyl-4-hydroxybenzylphosphonate, dioctadecyl-5-t-butyl-4-hydroxy-3-methylbenzylphosphonate, a calcium salt of 3,5-di-t-butyl-4-hydroxybenzylphosphonic acid monoester, and mixtures thereof, and the like.

### (12) Examples of Acylaminophenol Derivatives

4-Hydroxylauric acid anilide, 4-hydroxystearic acid anilide, octyl-N-(3,5-di-t-butyl-4-hydroxyphenyl) carbamate, and mixtures thereof, and the like.

(13) Examples of Esters of β-(3, 5-Di-t-butyl-4-hydroxyphenyl)propionic Acid and Following Monohydric or Polyhydric Alcohols

Methanol, ethanol, octanol, octadecanol, ethylene glycol, 1,3-propanediol, 1,4-butanediol, 1,6-hexanediol, 1, 9-nonanediol, neopentyl glycol, diethylene glycol, thioethylene glycol, spiroglycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2, 6, 7-trioxabicyclo[2, 2, 2]octane, and mixtures thereof, and the like.

(14) Examples of Esters of β-(5-t-Butyl-4-hydroxy-3-methylphenyl)propionic Acid and Following Monohydric or Polyhydric Alcohols

Methanol, ethanol, octanol, octadecanol, ethylene glycol, 1,3-propanediol, 1,4-butanediol, 1,6-hexanediol, 1, 9-nonanediol, neopentyl glycol, diethylene glycol, thioethylene glycol, spiroglycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2, 6, 7-trioxabicyclo[2, 2, 2]octane, and mixtures thereof, and the like.

(15) Examples of Esters of β-(3,5-Dicyclohexyl-4-hydroxyphenyl)propionic Acid and Following Monohydric or Polyhydric Alcohols

Methanol, ethanol, octanol, octadecanol, ethylene glycol, 1,3-propanediol, 1,4-butanediol, 1,6-hexanediol, 1, 9-nonanediol, neopentyl glycol, diethylene glycol, thioethylene glycol, spiroglycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2, 6, 7-trioxabicyclo[2, 2, 2]octane, and mixtures thereof, and the like.

(16) Examples of Esters of 3,5-Di-t-butyl-4-hydroxyphenylacetic Acid and Following Monohydric or Polyhydric Alcohols

Methanol, ethanol, octanol, octadecanol, ethylene glycol, 1,3-propanediol, 1,4-butanediol, 1,6-hexanediol, 1, 9-nonanediol, neopentyl glycol, diethylene glycol, thioethylene glycol, spiroglycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2, 6, 7-trioxabicyclo[2, 2, 2]octane, and mixtures thereof, and the like.

(17) Examples of Amide of β-(3,5-di-t-butyl-4-hydroxyphenyl)propionic acid

N,N′-bis[3-(3′, 5′-di-t-butyl-4′-hydroxyphenyl) propionyl]hydrazine, N,N′-bis[3-(3′, 5′-di-t-butyl-4′-hydroxyphenyl) propionyl]hexamethylenediamine, N,N′-bis[3-(3′, 5′-di-t-butyl-4′-hydroxyphenyl) propionyl]trimethylenediamine and mixtures thereof, and the like.

Examples of the sulfur-based antioxidants include the following.

Dilauryl 3,3′-thiodipropionate, tridecyl 3, 3′-thiodipropionate, dimyristyl 3, 3′-thiodipropionate, distearyl 3,3′-thiodipropionate, lauryl stearyl 3, 3′-thiodipropionate, neopentanetetrayl tetrakis(3-laurylthiopropionate), and the like.

Examples of the phosphorus-based antioxidants include the following. As the phosphorus-based antioxidant, the following compounds may be used singly, or two or more may be used in combination.

Triphenyl phosphite, tris(nonylphenyl)phosphite, tris(2,4-di-t-butylphenyl)phosphite, trilauryl phosphite, trioctadecyl phosphite, distearyl pentaerythritol diphosphite, diisodecyl pentaerythritol diphosphite, bis(2,4-di-t-butylphenyl) pentaerythritol diphosphite, bis(2,4-di-t-butyl-6-methylphenyl) pentaerythritol diphosphite, bis(2,6-di-t-butyl-4-methylphenyl) pentaerythritol diphosphite, bis(2, 4, 6-tri-t-butylphenyl) pentaerythritol diphosphite, tristearyl sorbitol triphosphite, tetrakis(2,4-di-t-butylphenyl)-4, 4′-diphenylene diphosphonite, 2,2′-methylenebis(4,6-di-t-butylphenyl) 2-ethylhexyl phosphite, 2, 2′-ethylidenebis(4,6-di-t-butylphenyl) fluorophosphite, bis(2,4-di-t-butyl-6-methylphenyl) ethyl phosphite, bis(2,4-di-t-butyl-6-methylphenyl) methyl phosphite, 2-(2, 4, 6-tri-t-butylphenyl)-5-ethyl-5-butyl-1, 3,2-oxaphosphorinane, 2, 2', 2″-nitrilo[triethyl-tris(3, 3′, 5, 5′-tetra-t-butyl-1, 1′-biphenyl-2, 2′-diyl) phosphite, 6-[3-(3-t-butyl-4-hydroxy-5-methylphenyl) propoxy]-2, 4, 8, 10-tetra-t-butyldibenzo[d, f][1, 3, 2]dioxaphosphepin, and mixtures thereof, and the like.

Examples of the age resisters include quinoline-based age resisters such as polymers of 2, 2, 4-trimethyl-1, 2-dihydroquinoline; monophenol-based age resisters such as 2, 6-di-t-butyl-4-methylphenol and styrenated phenol; and bis-, tris-, and polyphenol-based age resisters such as tetrakis-[methylene-3-(3′, 5′-di-t-butyl-4′-hydroxyphenyl) propionate]methane. These may be used singly, or two or more may be used in combination. Among them, quinoline-based age resisters are preferred.

Examples of the ultraviolet absorbing agent include the following. As the ultraviolet absorbing agent, the following compounds may be used singly, or two or more may be used in combination.

### (1) Examples of Salicylate Derivatives

phenyl salicylate, 4-t-butylphenyl salicylate, 2, 4-di-t-butylphenyl 3′, 5′-di-t-butyl-4′-hydroxybenzoate, 4-t-octylphenyl salicylate, bis(4-t-butylbenzoyl) resorcinol, benzoylresorcinol, hexadecyl 3′, 5′-di-t-butyl-4′-hydroxybenzoate, octadecyl 3′, 5′-di-t-butyl-4′-hydroxybenzoate, 2-methyl-4, 6-di-t-butylphenyl 3′, 5′-di-t-butyl-4′-hydroxybenzoate and mixtures thereof, and the like.

### (2) Examples of 2-Hydroxybenzophenone Derivatives

2, 4-Dihydroxybenzophenone, 2-hydroxy-4-methoxybenzophenone, 2-hydroxy-4-octoxybenzophenone, 2, 2′-dihydroxy-4-methoxybenzophenone, bis(5-benzoyl-4-hydroxy-2-methoxyphenyl) methane, 2, 2′, 4, 4′-tetrahydroxybenzophenone, and mixtures thereof, and the like.

### (3) Examples of 2-(2′-Hydroxyphenyl)Benzotriazoles

2-(2-Hydroxy-5-methylphenyl)benzotriazole, 2-(3′, 5′-di-t-butyl-2′-hydroxyphenyl)benzotriazole, 2-(5′-t-butyl-2′-hydroxyphenyl)benzotriazole, 2-(2′-hydroxy-5′-t-octylphenyl)benzotriazole, 2-(3-t-butyl-2-hydroxy-5-methylphenyl)-5-chlorobenzotriazole, 2-(3′-s-butyl-2′-hydroxy-5′-t-butylphenyl) benzotriazole, 2-(2′-hydroxy-4′-octyloxyphenyl)benzotriazole, 2-(3′, 5′-di-t-amyl-2′-hydroxyphenyl)benzotriazole, 2-[2′-hydroxy-3′, 3′-bis(α, α-dimethylbenzyl)phenyl]-2H-benzotriazole, 2-[(3′-t-butyl-2′-hydroxyphenyl)-5′-(2-octyloxycarbonylethyl)phenyl]-5-chlorobenzotriazole, 2-[3′-t-butyl-5′-[2-(2-ethylhexyloxy) carbonylethyl]-2′-hydroxyphenyl]-5-chlorobenzotriazole, 2-[3′-t-butyl-3′-hydroxy-5′-(2-methoxycarbonylethyl)phenyl]-5-chlorobenzotriazole, 2-[3′-t-butyl-2′-hydroxy-5′-(2-methoxycarbonylethyl)phenyl]benzotriazole, 2-[3′-t-butyl-2′-hydroxy-5-(2-octyloxycarbonylethyl)phenyl]benzotriazole, 2-[3′-t-butyl-2′-hydroxy-5′-[2-(2-ethylhexyloxy) carbonylethyl]phenyl]benzotriazole, 2-[2-hydroxy-3-(3, 4, 5, 6-tetrahydrophthalimidomethyl)-5-methylphenyl]benzotriazole, 2-(3,5-di-t-butyl-2-hydroxyphenyl)-5-chlorobenzotriazole, mixtures of 2-(3′-dodecyl-2′-hydroxy-5′-methylphenyl)benzotriazole and 2-[3′-t-butyl-2′-hydroxy-5′-(2-isooctyloxycarbonylethyl)phenyl]benzotriazole, 2, 2′-methylenebis[6-(2H-benzotriazol-2-yl)-4-(1, 1, 3, 3-tetramethylbutyl)phenol, 2, 2′-methylenebis[4-t-butyl-6-(2H-benzotriazol-2-yl)phenol], condensates of poly(3 to 11) (ethylene glycol) and 2-[3′-t-butyl-2′-hydroxy-5′-(2-methoxycarbonylethyl)phenyl]benzotriazole, condensates of poly (3 to 11) (ethylene glycol) and methyl 3-[3-(2H-benzotriazol-2-yl)-5-t-butyl-4-hydroxyphenyl]propionate, 2-ethylhexyl 3-[3-t-butyl-5-(5-chloro-2H-benzotriazol-2-yl)-4-hydroxyphenyl]propionate, octyl 3-[3-t-butyl-5-(5-chloro-2H-benzotriazol-2-yl)-4-hydroxyphenyl]propionate, methyl 3-[3-t-butyl-5-(5-chloro-2H-benzotriazol-2-yl)-4-hydroxyphenyl]propionate, 3-[3-t-butyl-5-(5-chloro-2H-benzotriazol-2-yl)-4-hydroxyphenyl]propionic acid, and mixtures thereof, and the like.

Examples of the light stabilizers include the following. As the light stabilizer, the following compounds may be used singly, or two or more may be used in combination.

### (1) Examples of Hindered Amine-Based Light Stabilizer

bis(2, 2, 6, 6-tetramethyl-4-piperidyl)sebacate, bis(2, 2, 6, 6-tetramethyl-4-piperidyl) succinate, bis(1, 2, 2, 6, 6-pentamethyl-4-piperidyl)sebacate, bis(N-octoxy-2, 2, 6, 6-tetramethyl-4-piperidyl)sebacate, bis(N-benzyloxy-2, 2, 6, 6-tetramethyl-4-piperidyl)sebacate, bis(N-cyclohexyloxy-2, 2, 6, 6-tetramethyl-4-piperidyl)sebacate, bis(1, 2, 2, 6, 6-pentamethyl-4-piperidyl) 2-(3,5-di-t-butyl-4-hydroxybenzyl)-2-butyl malonate, bis(1-acroyl-2, 2, 6, 6-tetramethyl-4-piperidyl) 2, 2-bis(3, 5-di-t-butyl-4-hydroxybenzyl)-2-butyl malonate, bis(1, 2, 2, 6, 6-pentamethyl-4-piperidyl) decanedioate, 2, 2, 6, 6-tetramethyl-4-piperidyl methacrylate, 4-[3-(3,5-di-t-butyl-4-hydroxyphenyl) propionyloxy]-1-[2-(3-(3,5-di-t-butyl-4-hydroxyphenyl) propionyloxy)ethyl]-2, 2, 6, 6-tetramethylpiperidine, 2-methyl-2-(2, 2, 6, 6-tetramethyl-4-piperidyl) amino-N-(2, 2, 6, 6-tetramethyl-4-piperidyl) propionamide, tetrakis(2, 2, 6, 6-tetramethyl-4-piperidyl) 1, 2, 3, 4-butanetetracarboxylate, tetrakis(1, 2, 2, 6, 6-pentamethyl-4-piperidyl) 1, 2, 3, 4-butanetetracarboxylate, and a mixed esterified product of 1, 2, 3, 4-butanetetracarboxylic acid with 1, 2, 2, 6, 6-pentamethyl-4-piperidinol and 1-tridecanol,

a mixed esterified product of 1, 2, 3, 4-butanetetracarboxylic acid with 2, 2, 6, 6-tetramethyl-4-piperidinol and 1-tridecanol, a mixed esterified product of 1, 2, 3, 4-butanetetracarboxylic acid with 1, 2, 2, 6, 6-pentamethyl-4-piperidinol and 3, 9-bis(2-hydroxy-1, 1-dimethylethyl)-2, 4, 8, 10-tetraoxaspiro[5.5]undecane, a mixed esterified product of 1, 2, 3, 4-butanetetracarboxylic acid with 2, 2, 6, 6-tetramethyl-4-piperidinol and 3,9-bis(2-hydroxy-1,1-dimethylethyl)-2, 4, 8, 10-tetraoxaspiro[5.5]undecane, a polycondensate of dimethyl succinate and 1-(2-hydroxyethyl)-4-hydroxy-2, 2, 6, 6-tetramethylpiperidine, poly[(6-morpholino-1, 3, 5-triazin-2, 4-diyl) ((2, 2, 6, 6-tetramethyl-4-piperidyl) imino) hexamethylene ((2, 2, 6, 6-tetramethyl-4-piperidyl) imino)], poly[(6-(1, 1, 3, 3-tetramethylbutyl) imino-1, 3, 5-triazin-2, 4-diyl((2, 2, 6, 6-tetramethyl-4-piperidyl) imino) hexamethylene ((2, 2, 6, 6-tetramethyl-4-piperidyl) imino)], a polycondensate of N,N′-bis(2, 2, 6, 6-tetramethyl-4-piperidyl) hexamethylenediamine and 1,2-dibromoethane, N,N′, 4, 7-tetrakis[4,6-bis(N-butyl-N-(2, 2, 6, 6-tetramethyl-4-piperidyl)amino)-1, 3, 5-triazin-2-yl]-4,7-diazadecane-1, 10-diamine, N,N′, 4-tris[4,6-bis(N-butyl-N-(2, 2, 6, 6-tetramethyl-4-piperidyl)amino)-1, 3, 5-triazin-2-yl]-4, 7-diazadecane-1,10-diamine, N,N′, 4, 7-tetrakis[4,6-bis(N-butyl-N-(1, 2, 2, 6, 6-pentamethyl-4-piperidyl)amino)-1, 3, 5-triazin-2-yl]-4,7-diazadecane-1,10-diamine, N,N′, 4-tris[4,6-bis(N-butyl-N-(1, 2, 2, 6, 6-pentamethyl-4-piperidyl)amino)-1, 3, 5-triazin-2-yl]-4,7-diazadecane-1, 10-diamine and mixtures thereof, and the like.

### (2) Examples of Acrylate-Based Light Stabilizers

Ethyl α-cyano-β, β-diphenyl acrylate, isooctyl α-cyano-β, β-diphenyl acrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate, and N—(B-carbomethoxy-β-cyanovinyl)-2-methylindoline, and mixtures thereof, and the like.

### (3) Examples of Nickel-Based Light Stabilizers

The nickel complex of 2, 2′-thiobis-[4-(1, 1, 3, 3-tetramethylbutyl)phenol], nickel dibutyldithiocarbamate, nickel salts of monoalkyl esters, nickel complexes of ketoximes, and mixtures thereof, and the like.

### (4) Examples of Oxamide-Based Light Stabilizers

4, 4′-Dioctyloxyoxanilide, 2,2′-diethoxyoxanilide, 2, 2′-dioctyloxy-5, 5′-di-t-butylanilide, 2, 2′-didodecyloxy-5, 5′-di-t-butylanilide, 2-ethoxy-2′-ethyloxanilide, N,N′-bis(3-dimethylaminopropyl)oxamide, 2-ethoxy-5-t-butyl-2′-ethoxyanilide, 2-ethoxy-5, 4′-di-t-butyl-2′-ethyloxanilide, and mixtures thereof, and the like.

### (5) Examples of 2-(2-Hydroxyphenyl)-1, 3, 5-Triazine-Based Light Stabilizers

2, 4, 6-Tris(2-hydroxy-4-octyloxyphenyl)-1, 3, 5-triazine, 2-(2-hydroxy-4-octyloxyphenyl)-4, 6-bis(2, 4-dimethylphenyl)-1, 3, 5-triazine, 2-[2,4-dihydroxyphenyl-4, 6-bis(2, 4-dimethylphenyl]-1, 3, 5-triazine, 2,4-bis(2-hydroxy-4-propyloxyphenyl)-6-(2,4-dimethylphenyl)-1, 3, 5-triazine, 2-(2-hydroxy-4-octyloxyphenyl)-4, 6-bis(4-methylphenyl)-1, 3, 5-triazine, 2-(2-hydroxy-4-dodecyloxyphenyl)-4, 6-bis(2, 4-dimethylphenyl)-1, 3, 5-triazine, 2-[2-hydroxy-4-(2-hydroxy-3-butyloxypropoxy)phenyl]-4, 6-bis(2, 4-dimethylphenyl)-1, 3, 5-triazine, 2-[2-hydroxy-4-(2-hydroxy-3-octyloxypropoxy)phenyl]-4, 6-bis(2, 4-dimethylphenyl)-1, 3, 5-triazine, and mixtures thereof, and the like.

Examples of the metal deactivator include the following.

N,N′-diphenyloxamide, N-salicylal-N′-salicyloylhydrazine, N,N′-bis(salicyloyl) hydrazine, N,N′-bis(3,5-di-t-butyl-4-hydroxyphenylpropionyl) hydrazine, 3-salicyloylamino-1, 2, 4-triazole, bis(benzylidene) oxalyl dihydrazide, oxanilide, isophthaloyl dihydrazide, sebacoyl bisphenyl hydrazide, N,N′-bis(salicyloyl) oxalyl dihydrazide, N,N′-bis(salicyloyl) thiopropionyl dihydrazide and mixtures thereof, and the like.

Examples of the peroxide scavenger include esters of β-thiodipropionic acid, mercaptobenzimidazole, the zinc salt of 2-mercaptobenzimidazole, the zinc salt of dibutyldithiocarbamic acid, dioctadecyl disulfide, pentaerythritol tetrakis(β-dodecylmercapto) propionate, and mixtures thereof.

Examples of the polyamide stabilizers include copper or divalent manganese salts of iodides or phosphorus compounds, and mixtures thereof.

Examples of the hydroxyamine include N, N-dibenzylhydroxyamine, N, N-diethylhydroxyamine, N, N-dioctylhydroxyamine, N, N-dilaurylhydroxyamine, N, N-ditetradecylhydroxyamine, N, N-dihexadecylhydroxyamine, N, N-dioctadecylhydroxyamine, N-hexadecyl-N-octadecylhydroxyamine, N-heptadecyl-N-octadecylhydroxyamine and mixtures thereof, and the like.

Examples of the neutralizing agent include calcium stearate, zinc stearate, magnesium stearate, hydrotalcite (basic magnesium aluminum hydroxycarbonate hydrate), melamine, amine, polyamides, polyurethanes and mixtures thereof, and the like.

Examples of the lubricant include aliphatic hydrocarbons such as paraffins and waxes, higher fatty acids having 8 to 22 carbon atoms, metal (Al, Ca, Mg, and Zn) salts of higher fatty acids having 8 to 22 carbon atoms, aliphatic alcohols having 8 to 22 carbon atoms, polyglycols, esters of higher fatty acids having 4 to 22 carbon atoms and aliphatic monohydric alcohols having 4 to 18 carbon atoms, higher aliphatic amides having 8 to 22 carbon atoms, silicone oils, and rosin derivatives.

Examples of the nucleating agent include the following: sodium 2, 2′-methylenebis(4,6-di-t-butylphenyl) phosphate, dihydroxyaluminum[2,2′-methylenebis(4,6-di-t-butylphenyl)phosphate], hydroxyaluminum bis[2, 2′-methylenebis(4,6-di-t-butylphenyl)phosphate], aluminum tris[2, 2′-methylenebis(4,6-di-t-butylphenyl)phosphate], sodium bis(4-t-butylphenyl)phosphate, metal salts of benzoates such as sodium benzoate, aluminum p-t-butylbenzoate, 1, 3:2, 4-bis(O-benzylidene) sorbitol, 1, 3:2, 4-bis(O-methylbenzylidene) sorbitol, 1, 3:2, 4-bis(O-ethylbenzylidene) sorbitol, 1,3-O-3, 4-dimethylbenzylidene-2, 4-O-benzylidene sorbitol, 1,3-O-benzylidene-2, 4-O-3, 4-dimethylbenzylidene sorbitol, 1,3:2, 4-bis(0-3,4-dimethylbenzylidene) sorbitol, 1,3-O-p-chlorobenzylidene-2, 4—O-3, 4-dimethylbenzylidene sorbitol, 1, 3—O-3, 4-dimethylbenzylidene-2, 4—O-p-chlorobenzylidene sorbitol, 1, 3:2, 4-bis(0-p-chlorobenzylidene) sorbitol, and mixtures thereof.

Examples of the filler include calcium carbonate, silicates, glass fibers, asbestos, talc, kaolin, mica, barium sulfate, carbon black, carbon fibers, zeolite, and mixtures thereof.

Among these additives, those preferably used are phenol-based antioxidants, phosphorus-based antioxidants, ultraviolet absorbing agents, hindered amine-based light stabilizers, peroxide scavengers and neutralizing agents.

Examples of particularly preferred phenol-based antioxidants include the following compounds.

octyl-3-(3,5-di-t-butyl-4-hydroxyphenyl) propionate, pentaerythritol tetrakis-3-(3,5-di-t-butyl-4-hydroxyphenyl) propionate, 2,2′-thiobis(6-t-butylphenol), 4, 4′-thiobis(3-methyl-6-t-butylphenol), 2, 2′-methylenebis(4-methyl-6-t-butylphenol), 2, 2′-methylenebis(4-ethyl-6-t-butylphenol), 2,2′-methylenebis[4-methyl-6-(α-methylcyclohexyl)phenol], 2, 2′-methylenebis(4-methyl-6-cyclohexylphenol), 2, 2′-methylenebis(4,6-di-t-butylphenol), 2, 2′-ethylydenebis(4,6-di-t-butylphenol), 4,4′-methylenebis(6-t-butyl-2-methylphenol), 4,4′-methylenebis(2,6-di-t-butylphenol), 4,4′-butylidenebis(3-methyl-6-t-butylphenol), 1,1-bis(4-hydroxyphenyl)cyclohexane, 1,1-bis(5-t-butyl-4-hydroxy-2-methylphenyl)butane, 1, 1, 3-tris(5-t-butyl-4-hydroxy-2-methylphenyl)butane, ethylene glycol bis[3,3-bis(3′-t-butyl-4′-hydroxyphenyl) butyrate], 2-t-butyl-6-(3′-t-butyl-5′-methyl-2′-hydroxybenzyl)-4-methylphenyl acrylate, 2, 4-di-t-pentyl-6-[1-(2-hydroxy-3, 5-di-t-pentylphenyl)ethyl]phenyl acrylate, 2, 4, 6-tris(3,5-di-t-butyl-4-phenoxy)-1, 3, 5-triazine, tris(4-t-butyl-3-hydroxy-2, 6-dimethylbenzyl)isocyanurate, bis(3,5-di-t-butyl-4-hydroxybenzyl)isocyanurate, tris[2-(3′, 5′-di-t-butyl-4′-hydroxycinnamoyloxy)ethyl]isocyanurate, diethyl-3, 5-di-t-butyl-4-hydroxybenzylphosphonate, di-n-octadecyl-3, 5-di-t-butyl-4-hydroxybenzylphosphonate, a calcium salt of 3,5-di-t-butyl-4-hydroxybenzylphosphonic acid monoester, n-octadecyl 3-(3,5-di-t-butyl-4-hydroxyphenyl) propionate, neopentane tetrayltetrakis(3,5-di-t-butyl-4-hydroxycinnamate), thiodiethylenebis(3,5-di-t-butyl-4-hydroxycinnamate), 1, 3, 5-trimethyl-2, 4, 6-tris(3,5-di-t-butyl-4-hydroxybenzyl)benzene, 3, 6-dioxaoctamethylenebis(3,5-di-t-butyl-4-hydroxycinnamate), hexamethylenebis(3,5-di-t-butyl-4-hydroxycinnamate), triethylene glycol bis(5-t-butyl-4-hydroxy-3-methylcinnamate), N,N′-bis[3-(3′, 5′-di-t-butyl-4′-hydroxyphenyl) propionyl]hydrazine, N,N′-bis[3-(3′, 5′-di-t-butyl-4′-hydroxyphenyl) propionyl]hexamethylenediamine, and the like.

Examples of particularly preferred phosphorus-based antioxidants include the following compounds.

tris(nonylphenyl)phosphite, tris(2,4-di-t-butylphenyl)phosphite, distearyl pentaerythritol diphosphite, bis(2,4-di-t-butylphenyl) pentaerythritol diphosphite, bis(2,4-di-t-butyl-6-methylphenyl) pentaerythritol diphosphite, bis(2,6-di-t-butyl-4-methylphenyl) pentaerythritol diphosphite, tetrakis(2,4-di-t-butylphenyl)-4, 4′-diphenylene diphosphite, 2,2′-methylenebis(4,6-di-t-butylphenyl) 2-ethylhexyl phosphite, 2,2′-ethylidenebis(4,6-di-t-butylphenyl) fluorophosphite, bis(2,4-di-t-butyl-6-methylphenyl)ethylphosphite, 2-(2, 4, 6-tri-t-butylphenyl)-5-ethyl-5-butyl-1, 3, 2-oxaphosphorinane, 2, 2′, 2∝′-nitrilo[triethyl-tris(3, 3′, 5, 5′-tetra-t-butyl-1, 1′-biphenyl-2, 2′-diyl)phosphite, 6-[3-(3-t-butyl-4-hydroxy-5-methylphenyl) propoxy]-2, 4, 8, 10-tetra-t-butyldibenzo[d, f][1, 3, 2]dioxaphosphepine, and the like.

Examples of particularly preferred ultraviolet absorbing agents include the following compounds.

phenyl salicylate, 4-t-butylphenyl salicylate, 2, 4-di-t-butylphenyl 3′, 5′-di-t-butyl-4′-hydroxybenzoate, 4-t-octylphenyl salicylate, 2, 4-dihydroxybenzophenone, 2-hydroxy-4-methoxybenzophenone, 2-hydroxy-4-octoxybenzophenone, 2,2′-dihydroxy-4-methoxybenzophenone, bis(5-benzoyl-4-hydroxy-2-methoxyphenyl) methane, 2, 2′, 4, 4′-tetrahydroxybenzophenone, 2-(2-hydroxy-5-methylphenyl)benzotriazole, 2-(3′, 5′-di-t-butyl-2′-hydroxyphenyl)benzotriazole, 2-(5′-t-butyl-2′-hydroxyphenyl)benzotriazole, 2-(2′-hydroxy-5′-t-octylphenyl)benzotriazole, 2-(3-t-butyl-2-hydroxy-5-methylphenyl)-5-chlorobenzotriazole, 2-(3′-s-butyl-2′-hydroxy-5′-t-butylphenyl)benzotriazole, 2-(2′-hydroxy-4′-octyloxyphenyl) benzotriazole, 2-(3′, 5′-di-t-amyl-2′-hydroxyphenyl)benzotriazole, 2-[2′-hydroxy-3′, 5′-bis(α, α-dimethylbenzyl)phenyl]-2H-benzotriazole, and the like.

Examples of particularly preferred light stabilizers include the following compounds.

bis(2, 2, 6, 6-tetramethyl-4-piperidyl)sebacate, bis(1, 2, 2, 6, 6-pentamethyl-4-piperidyl)sebacate, bis(N-octoxy-2, 2, 6, 6-tetramethyl-4-piperidyl)sebacate, bis(N-benzyloxy-2, 2, 6, 6-tetramethyl-4-piperidyl)sebacate, bis(N-cyclohexyloxy-2, 2, 6, 6-tetramethyl-4-piperidyl)sebacate, bis(1, 2, 2, 6, 6-pentamethyl-4-piperidyl) 2-(3,5-di-t-butyl-4-hydroxybenzyl)-2-butyl malonate, bis(1-acroyl-2, 2, 6, 6-tetramethyl-4-piperidyl) 2, 2-bis(3, 5-di-t-butyl-4-hydroxybenzyl)-2-butyl malonate, bis(2, 2, 6, 6-tetramethyl-4-piperidyl) succinate, 2, 2, 6, 6-tetramethyl-4-piperidyl methacrylate, 4-[3-(3,5-di-t-butyl-4-hydroxyphenyl) propionyloxy]-1-[2-(3-(3,5-di-t-butyl-4-hydroxyphenyl) propionyloxy)ethyl]-2, 2, 6, 6-tetramethylpiperidine, 2-methyl-2-(2, 2, 6, 6-tetramethyl-4-piperidyl) amino-N-(2, 2, 6, 6-tetramethyl-4-piperidyl) propionamide, tetrakis(2, 2, 6, 6-tetramethyl-4-piperidyl) 1, 2, 3, 4-butanetetracarboxylate,

tetrakis(1, 2, 6, 6-pentamethyl-4-piperidyl) 1, 2, 3, 4-butanetetracarboxylate, a mixed esterified product of 1, 2, 3, 4-butanetetracarboxylic acid with 1, 2, 2, 6, 6-pentamethyl-4-piperidinol and 1-tridecanol, a mixed esterified product of 1, 2, 3, 4-butanetetracarboxylic acid with 2, 2, 6, 6-tetramethyl-4-piperidinol and 1-tridecanol, a mixed esterified product of 1, 2, 3, 4-butanetetracarboxylic acid with 1, 2, 2, 6, 6-pentamethyl-4-piperidinol and 3, 9-bis(2-hydroxy-1,1-dimethylethyl)-2, 4, 8, 10-tetraoxaspiro[5.5]undecane, a mixed esterified product of 1, 2, 3, 4-butanetetracarboxylic acid with 2, 2, 6, 6-tetramethyl-4-piperidinol and 3, 9-bis(2-hydroxy-1, 1-dimethylethyl)-2, 4, 8, 10-tetraoxaspiro[5.5]undecane, a polycondensate of dimethyl succinate and 1-(2-hydroxyethyl)-4-hydroxy-2, 2, 6, 6-tetramethylpiperidine, poly[(6-morpholino-1, 3, 5-triazin-2, 4-diyl) ((2, 2, 6, 6-tetramethyl-4-piperidyl) imino) hexamethylene ((2, 2, 6, 6-tetramethyl-4-piperidyl) imino)], poly[(6-(1, 1, 3, 3-tetramethylbutyl)-1, 3, 5-triazin-2, 4-diyl) ((2, 2, 6, 6-tetramethyl-4-piperidyl) imino) hexamethylene ((2, 2, 6, 6-tetramethyl-4-piperidyl) imino)], and the like.

### [Methods for Producing Resin and Resin Composition]

The methods for producing the polyethylene-based resin (2) and the polypropylene-based resin (3) are not particularly limited, and these resins may be, for example, those obtained by radical polymerization or those produced by polymerization using a catalyst containing a metal of group IVb, Vb, VIb or VIII of the periodic table. Examples of the catalyst containing such a metal include metal complexes having one or more ligands, for example, oxides, halogen compounds, alcoholates, esters, or aryls coordinated by π or σ bonds. These complexes may be metal complexes as they are, or may be supported on carriers such as magnesium chloride, titanium chloride, alumina, or silicon oxide. As the polyethylene-based resin (2), one produced using, for example, a Ziegler-Natta catalyst, a TNZ catalyst, a metallocene catalyst, or the Phillips catalyst is preferably used.

Recycled resins of the polyethylene-based resin (2) and the polypropylene-based resin (3) described above are also suitable as the polyethylene-based resin (2) and the polypropylene-based resin (3). Examples of such recycled resins include a recycled polyethylene resin, a recycled polypropylene resin, and a recycled propylene-ethylene block copolymer. The recycled resin here is, for example, one obtained by recycling a resin that has once shaped into a film or other form, and is, for example, often used in a pellet-like or powdery form processed from a shaped product such as a film.

Also in the case where the recycled resin is used, adjustment of the proportions of the amounts of the compound (1), the polyethylene-based resin (2) and the polypropylene-based resin (3) to be in the respective specified ranges can suppress coloration of the recycled resin during processing and provide a resin composition that is excellent in fluidity.

### (Method for Producing Resin Composition)

The resin composition can be produced by using any known method and apparatus to homogeneously mix the compound (1) represented by formula (1), the polyethylene-based resin (2), the polypropylene-based resin (3), and other resin and additive added if necessary, in amounts such that the proportion of the amount of the polyethylene-based resin (2) to the total amount of the polyethylene-based resin (2) and the polypropylene-based resin (3) is 60% by mass or more and less than 100% by mass. For example, the resin composition can be produced by a production method including at least a step of melt-kneading a mixture obtained by dry mixing these components in advance, thereby mutually mixing the components.

The resin composition thus obtained has favorable processing stability, and also the resin composition itself can be prevented from being colored during processing. Such an organic material is considered to be stable against, for example, thermal degradation and/or oxidization degradation during production, during processing and during use, and furthermore to be resistant to coloration due to a radical generated during processing, and serves as a high-quality product.

The present invention also provides a method for stabilizing an organic material, the method including adding a compound (1) represented by formula (1):

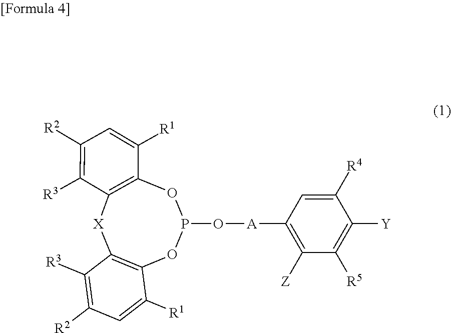

wherein
R¹, R², R⁴ and R⁵ each independently represent a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group,
R³ each independently represents a hydrogen atom or an alkyl group having 1 to 8 carbon atoms,
X represents a single bond, a sulfur atom or a group —CH(—R⁶)—, wherein R⁶ represents a hydrogen atom, an alkyl group having 1 to 8 carbon atoms or a cycloalkyl group having 5 to 8 carbon atoms,
A represents an alkylene group having 1 to 8 carbon atoms or a group *—C(═O)—R⁷—, wherein R⁷ represents a single bond or an alkylene group having 1 to 8 carbon atoms, and * represents a bond to oxygen,
any one of Y and Z represents a hydroxyl group, an alkoxy group having 1 to 8 carbon atoms or an aralkyloxy group having 7 to 12 carbon atoms, and the other thereof represents a hydrogen atom or an alkyl group having 1 to 8 carbon atoms,
   to an organic material containing a polyethylene-based resin (2) and a polypropylene-based resin (3), wherein
an amount of a constituent unit derived from ethylene is 67% by mol or more based on an amount of the entire constituent unit in the polyethylene-based resin (2), and
a proportion of an amount of the polyethylene-based resin (2) to a total amount of the polyethylene-based resin (2) and the polypropylene-based resin (3) is 60% by mass or more and less than 100% by mass. The description and preferred embodiments described above for the resin composition of the present invention also apply again to the stabilizing method of the present invention.

In the case of dry mixing, powders may be placed in a bag, which is manually rotated to mix the powders, or a Henschel mixer, a sand mill, an edge runner, a Taninaka-type crusher, or the like can also be used. In the case of melt-kneading, a Banbury mixer, a single-screw extruder, a twin-screw extruder or the like can be used or two or more extruders can be used in combination. A twin-screw extruder is preferably used for melt-kneading in view of easily enhancing productivity. The temperature during melt-kneading (for example, the temperature set on an extruder) is 170° C. or more, preferably 180 to 300° C., more preferably 190 to 270° C., and further preferably 190° C. to 250° C. in view of easily reducing the coloration of the resin composition itself.

### <Molded Article of Resin Composition>

A molded article can be produced by molding the resin composition of the present invention by a known molding method. Examples of the molding method include an injection molding method, a press molding method, a vacuum molding method, a vacuum press molding method, a compressed-air molding method, a foam molding method, and an extrusion method, and, for example, an injection molded article, a press molded article, a vacuum molded article, a vacuum press molded article, a compressed-air molded article, a foam molded article, and an extruded article can be respectively obtained by these molding methods. A preferred molding method is an injection molding method in view of capability of applying to various molded products and also versatility. Examples of the injection molding method include a common injection molding method, an injection foam molding method, a supercritical injection foam molding method, an ultra-high speed injection molding method, an injection compression molding method, an injection press molding method, a gas-assist injection molding method, a sandwich molding method, a sandwich foam molding method, and an insert/outsert molding method.

The application of a molded article obtained by molding the resin composition of the present invention by the above molding method is not particularly limited, and preferable examples thereof include materials for various industrial parts, including parts for automobile interiors and exteriors, such as bumpers, door trims, pillars, instrument panels, consoles, rocker panels, arm rests, door panels, and spear tire covers; parts for vacuum cleaners, televisions, and other home appliance applications; various housing facility equipment parts, various industrial parts, and various building material parts; as well as a wide variety of films such as heavy-duty bags, shrinks, general packaging, thin films, protective films (protection films), extrusion laminated films, extruded films, and foam-molded films.

### EXAMPLES

The present invention will be more specifically described below by way of Examples and Comparative Examples, but the present invention is not limited thereto at all. In the following Examples and Comparative Examples, “part(s)” means “part(s) by weight”, unless particularly noted.

### <Components>

Components used in Examples and Comparative Examples are described below.

### (Thermoplastic Resin)

Linear low density polyethylene resin (LLDPE) (MER value: 2 g/10 min, manufactured by Sumitomo Chemical Co., Ltd., copolymer of ethylene and 1-butene, amount of constituent unit derived from ethylene: 96% by mol, density 920 kg/m³)
Homopolypropylene resin (HPP) (MFR value: 18 g/10 min, manufactured by Sumitomo Chemical Co., Ltd.) (Processing stabilizers)
Compound A:
2, 4, 8, 10-tetra-t-butyl-6-[3-(3-methyl-4-hydroxy-5-t-butylphenyl) propoxy]dibenzo[d, f][1, 3, 2]dioxaphosphepine (Sumilizer (R) GP, manufactured by Sumitomo Chemical Co., Ltd.)
Compound B: stearyl 3-(3,5-di-t-butyl-4-hydroxyphenyl) propionate (IRGANOX 1076, manufactured by BASF SE)
Compound C: tris(2,4-di-tert-butylphenyl)phosphite (IRGAFOS 168, manufactured by BASF SE)

The melt flow rate (MFR) of the polyethylene-based resin (2) was measured by the method A under the conditions of a temperature of 190° C. and a load of 21.18 N according to the method prescribed in JIS K7210-2014. The MFR of the polypropylene-based resin (3) was measured by the method A under the conditions of a temperature of 230° C. and a load of 21.18 N according to the method prescribed in JIS K7210-2014.

The density of the polyethylene-based resin (2) was measured by the method A prescribed in JIS K7112-1980.

### Example 1

99 parts of LLDPE, 1 part of HPP, 0.05 parts of calcium stearate (manufactured by Nitto Chemical Industry Co., Ltd.), and 0.05 parts of the compound A were dry-blended, and the obtained mixture was kneaded under a nitrogen atmosphere under the conditions of a temperature of 220° C. and a screw rotation speed of 80 rpm using a twin-screw extruder having a cylinder diameter of 32 mm (BTN-32, PLABOR) to obtain pellets.

### Examples 2 to 5 and Comparative Examples 1 to 10

Pellets were obtained in the same manner as in Example 1 except that the compound A, the compound B or the compound C was added in an amount in parts by weight as described in Table 1 and dry-blended.

TABLE 1

| | Amount added in parts by weight | | | | | Processing stability | | | |
|---|---|---|---|---|---|---|---|---|---|
| | | | Compound | Compound | Compound | MFR | | Coloring resistance | |
| | LLDPE | HPP | A | B | C | (g/10 min) | Evaluation | ΔYI | Evaluation |
| Example 1 | 99 | 1 | 0.050 | | | 1.74 | Good | 1.16 | Good |
| Example 2 | 97 | 3 | 0.050 | | | 2.3 | Good | 1.13 | Good |
| Example 3 | 90 | 10 | 0.050 | | | 2.47 | Good | 0.98 | Good |
| Example 4 | 80 | 20 | 0.050 | | | 2.82 | Good | 1.53 | Good |
| Example 5 | 60 | 40 | 0.050 | | | 3.35 | Good | 1.80 | Good |
| Comparative | 100 | 0 | 0.050 | | | 2.28 | Good | 2.65 | Poor |
| Example 1 | | | | | | | | | |
| Comparative | 50 | 50 | 0.050 | | | 4.08 | Good | 3.03 | Poor |
| Example 2 | | | | | | | | | |
| Comparative | 100 | 0 | | 0.025 | 0.025 | 1.86 | Good | 2.55 | Poor |
| Example 3 | | | | | | | | | |
| Comparative | 97 | 3 | | 0.025 | 0.025 | 1.95 | Good | 2.15 | Poor |
| Example 4 | | | | | | | | | |
| Comparative | 90 | 10 | | 0.025 | 0.025 | 2.16 | Good | 2.11 | Poor |
| Example 5 | | | | | | | | | |
| Comparative | 80 | 20 | | 0.025 | 0.025 | 2.44 | Good | 2.34 | Poor |
| Example 6 | | | | | | | | | |
| Comparative | 50 | 50 | | 0.025 | 0.025 | 3.36 | Good | 3.59 | Poor |
| Example 7 | | | | | | | | | |
| Comparative | 97 | 3 | | 0.050 | 0.050 | 2.28 | Good | 2.73 | Poor |
| Example 8 | | | | | | | | | |
| Comparative | 80 | 20 | | 0.050 | 0.050 | 2.82 | Good | 3.35 | Poor |
| Example 9 | | | | | | | | | |
| Comparative | 60 | 40 | | 0.050 | 0.050 | 3.37 | Good | 3.22 | Poor |
| Example 10 | | | | | | | | | |

The pellets obtained in Examples 1 to 5 and Comparative Examples 1 to 10 were used to evaluate the processing stability and the coloring resistance by the following methods. The results obtained are shown in Table 1.

### (Processing Stability)

The pellets obtained were each kneaded under an air atmosphere under the conditions of a temperature of 280° C. and a screw rotation speed of 70 rpm using a single-screw extruder having a cylinder diameter of 30 mm (VS30-28 type extruder, manufactured by Tanabe Plastics Machinery Co., Ltd.) to measure the melt flow rate (MFR) of each of the pellets obtained.

The MFR was measured under the conditions of a temperature of 190° C. and a load of 21.18 N according to the method prescribed in JIS K7210-2014 with a melt flow index tester (Model No. 120-LABOT-50, manufactured by Yasuda Seiki Seisakusho, Ltd.). For a resin composition including a thermoplastic resin containing a polyethylene-based resin as a main component, there is a tendency that processing the resin composition by heat promotes crosslinking to thereby decrease its MFR. Therefore, as the MFR is higher, the processing stability is more favorable. The processing stability was evaluated in terms of the MFR obtained, according to the following criteria.

### Evaluation Criteria of Processing Stability

Good: a MFR of 1.5 or more
Poor: a MFR of less than 1.5

### (Coloring Resistance)

The pellets obtained were each kneaded under an air atmosphere under the conditions of a temperature of 280° C. and a screw rotation speed of 70 rpm using a single-screw extruder having a cylinder diameter of 30 mm (VS30-28 type extruder, manufactured by Tanabe Plastics Machinery Co., Ltd.) to obtain each of resin composition pellets after kneading. The yellow index (YI) values of the pellets before and after kneading were measured using a colorimeter (“CM-3500d” manufactured by Konica Minolta Japan, Inc.), to calculate the change in YI before and after kneading. A smaller change in YI (ΔYI) means that the coloration of the resin composition itself is more suppressed and that the coloring resistance is thus more excellent. The coloring resistance was evaluated in terms of the ΔYI obtained, according to the following criteria.

### Evaluation Criteria of Coloring Resistance

Good: a ΔYI of less than 2.1
Poor: a ΔYI of 2.1 or more

It was found from the results shown in Table 1 that not only favorable processing stability was maintained, but also the coloration of the resin composition itself was suppressed in each of the resin compositions of Examples 1 to 5. On the contrary, no sufficient coloration suppression effect was obtained in each case of Comparative Examples 1 to 10. In particular, no sufficient effect of suppressing coloration was obtained when the amount of the polypropylene-based resin was out of the range specified by the present application even in the case of use of the compound A. In addition, no sufficient effect of suppressing coloration was obtained also in the case of use of the compound B or the compound C, which was not the compound represented by formula (1).

### INDUSTRIAL APPLICABILITY

The present invention provides a resin composition that is excellent in processing stability and enhanced in coloring resistance.

1. A resin composition comprising a compound (1) represented by formula (1): 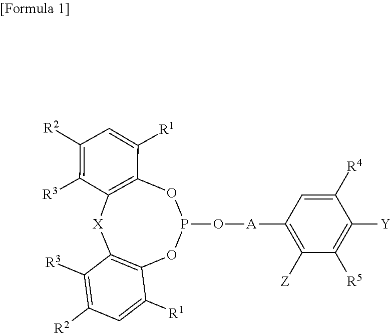
wherein
R¹, R², R⁴ and R⁵ each independently represent a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group,
R³ each independently represents a hydrogen atom or an alkyl group having 1 to 8 carbon atoms,
X represents a single bond, a sulfur atom or a group —CH(—R⁶)—, wherein R⁶ represents a hydrogen atom, an alkyl group having 1 to 8 carbon atoms or a cycloalkyl group having 5 to 8 carbon atoms,
A represents an alkylene group having 1 to 8 carbon atoms or a group *—C(═O)—R⁷—, wherein R⁷ represents a single bond or an alkylene group having 1 to 8 carbon atoms, and * represents a bond to oxygen,
one of Y and Z represents a hydroxyl group, an alkoxy group having 1 to 8 carbon atoms or an aralkyloxy group having 7 to 12 carbon atoms, and the other thereof represents a hydrogen atom or an alkyl group having 1 to 8 carbon atoms,
a polyethylene-based resin (2), and
a polypropylene-based resin (3), wherein
an amount of a constituent unit derived from ethylene is 67% by mol or more based on an amount of the entire constituent unit in the polyethylene-based resin (2), and
a proportion of an amount of the polyethylene-based resin (2) to a total amount of the polyethylene-based resin (2) and the polypropylene-based resin (3) is 60% by mass or more and less than 100% by mass.

2. The resin composition according to claim 1, wherein an amount of the compound (1) is 0.01 to 3% by mass based on the total amount of the polyethylene-based resin (2) and the polypropylene-based resin (3).

3. The resin composition according to claim 1, wherein an amount of a constituent unit derived from propylene is 60% by mol or more based on an amount of the entire constituent unit in the polypropylene-based resin (3).

4. The resin composition according to claim 1, wherein the amount of the constituent unit derived from ethylene is 80% by mol or more based on the amount of the entire constituent unit in the polyethylene-based resin (2).

5. The resin composition according to claim 1, wherein a total amount of the compound (1), the polyethylene-based resin (2) and the polypropylene-based resin (3) is 60% by mass or more based on a whole amount of the resin composition.

6. The resin composition according to claim 1, wherein the proportion of the amount of the polyethylene-based resin (2) to the total amount of the polyethylene-based resin (2) and the polypropylene-based resin (3) is 60% by mass or more and 99.9% by mass or less.

7. The resin composition according to claim 1, wherein the proportion of the amount of the polyethylene-based resin (2) to the total amount of the polyethylene-based resin (2) and the polypropylene-based resin (3) is 80% by mass or more and 99.9% by mass or less.

8. The resin composition according to claim 1, wherein the proportion of the amount of the polyethylene-based resin (2) to the total amount of the polyethylene-based resin (2) and the polypropylene-based resin (3) is 80% by mass or more and 99.5% by mass or less.

9. The resin composition according to claim 1, wherein in the polyethylene-based resin (2) and/or the polypropylene-based resin (3), an amount of a constituent unit derived from a diene-based monomer is 3% by mol or less based on an amount of the entire constituent unit.

10. The resin composition according to claim 1, wherein a density of the polyethylene-based resin (2) is 875 kg/m³ or more and 980 kg/m³ or less.

11. The resin composition according to claim 1, wherein the polyethylene-based resin (2) is high density polyethylene, low density polyethylene or linear low density polyethylene.

12. A method for stabilizing an organic material, the method comprising adding a compound (1) represented by formula (1): 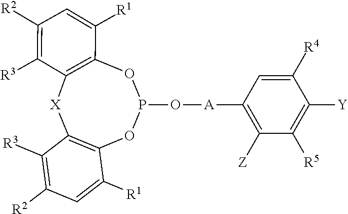
wherein
R¹, R², R⁴ and R⁵ each independently represent a hydrogen atom, an alkyl group having 1 to 8 carbon atoms, a cycloalkyl group having 5 to 8 carbon atoms, an alkylcycloalkyl group having 6 to 12 carbon atoms, an aralkyl group having 7 to 12 carbon atoms or a phenyl group,
R³ each independently represents a hydrogen atom or an alkyl group having 1 to 8 carbon atoms,
X represents a single bond, a sulfur atom or a group —CH(—R⁶)—, wherein R⁶ represents a hydrogen atom, an alkyl group having 1 to 8 carbon atoms or a cycloalkyl group having 5 to 8 carbon atoms,
A represents an alkylene group having 1 to 8 carbon atoms or a group *—C(═O)—R⁷—, wherein R⁷ represents a single bond or an alkylene group having 1 to 8 carbon atoms, and * represents a bond to oxygen,
one of Y and Z represents a hydroxyl group, an alkoxy group having 1 to 8 carbon atoms or an aralkyloxy group having 7 to 12 carbon atoms, and the other thereof represents a hydrogen atom or an alkyl group having 1 to 8 carbon atoms,
to an organic material containing a polyethylene-based resin (2) and a polypropylene-based resin (3), wherein
an amount of a constituent unit derived from ethylene is 67% by mol or more based on an amount of the entire constituent unit in the polyethylene-based resin (2), and
a proportion of an amount of the polyethylene-based resin (2) to a total amount of the polyethylene-based resin (2) and the polypropylene-based resin (3) is 60% by mass or more and less than 100% by mass.
